(19) United States
(12) Patent Application Publication
(10) Pub. No.: US 2002/0004819 A1
(43) Pub. Date: Jan. 10, 2002

(54) Device and method for data interception and updating

(76) Inventors: David Agassy, Tel Aviv (IL); Meir Agassy, Ramat Gan (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 09/900,859

(22) Filed: Jul. 10, 2001

Related U.S. Application Data
(60) Provisional application No. 60/216,952, filed on Jul. 10, 2000.
(60) Provisional application No. 60/269,680, filed on Feb. 20, 2001.

(51) Int. Cl. G06F 15/16

(52) U.S. Cl. 709/203; 709/246

(57) ABSTRACT

Apparatus for intercepting data communicated between a sender and a receiver, and conditionally altering that data, the apparatus comprising: an interception unit, capable of intercepting said data, setting information for storing predetermined device settings, access functionality, associated with said interception unit operable to access information within said intercepted data, and a search and replace unit, associated with both said interception unit and said access functionality, for conditionally altering the intercepted data in response to said accessed information and said device settings. The device is useful for dynamically updating web pages and the like and said updating may be made conditional on communication control information such as the identity of an intended recipient as well as data content.

### RELATIONSHIP TO EXISTING APPLICATIONS

This application claims priority from:

U.S. provisional application No. 60/216,952 and Filed Jul. 10, 2000

U.S. provisional application No. 60/269,680, Filed Feb. 20, 2001

### FIELD OF THE INVENTION

The present invention relates to systems and methods of dynamically updating data sent from a server to a client, specifically data sent over a network.

### BACKGROUND OF THE INVENTION

The Internet has created a demand for customized, up-to-date, content.

Advertisers want specific users to get their advertisements. Corporations have grown whose business is to deliver commercial advertisements to users who are most likely to want the products advertised. These corporations compile huge data repositories of users' browsing habits, and based on those habits, target particular commercial campaigning at those users. These companies are paid by advertisers, and give a percentage of the advertising revenue to the site serving the page containing the advertisement. In order for centralized advertising to work the site serving the page containing the advertisement must have references to the advertising serving company. These references must be maintained. If the content-server wishes to use a different advertisement company, or not use any advertisement company but sell their own space, their web sites have to be manually updated.

Further, banner advertisements are working less and less. Typical “click through” rates on advertisements are low and getting lower as banner advertisements are commonly ignored. Companies are moving away from the once-common banner advertisement, and replacing them with larger ads appearing more prominently in the content.

Free ISP's deliver internet content in exchange for some of the users screen space, on which they place advertisements. These ISP's are paid by companies who advertise products on the user's screen space. Users generally ignore this space, rarely “clicking through” on advertisements.

Web hosts create interconnecting pages that have many links. Objects within those sites move around as sites change, creating the common phenomenon of broken links. Whichever a foreign object changes its location, references must be changed. This can be time consuming and expensive for the site owner. Dynamically generated pages help alleviate this problem, by allowing a server to generate pages on the fly, and to generate the links on the fly. In well-constructed dynamically generated pages the links may be a reference to a variable, and changing that variable only once will change all the links on that site. Dynamically-generated pages do nothing to help with the millions of sites that have already be created, nor do they help any sites that are being created as static HTML pages, or that are written with the links hard-coded into the page.

Many sites wish to tailor their content to their individual users. These sites compile data stores of their users, tracking where the user goes within their site. This data is used to create a site that is more tailored to a user's requirements. A site cannot start generating individualized content until a user has visited the site repeatedly. When a user first comes to the site, that user is served a generic page. In order for a site to track a user to generate these individualized sites, the site either has to force the user to log in, which many users are reluctant to do, place cookies on a users machine, which many users don't allow or may erase regularly, or try to track the user by IP addresses, which can be meaningless as many users do not have fixed IP addresses.

ISP's have access to a users surfing habits, but do not give that information out to site owners. Users are becoming more and more conscious and concerned about their privacy, and do not want their (the users) ISP's divulging information about them (the user).

A means is therefore needed of automatically updating Internet content. Likewise a means is required of providing personalized content updating, advantageously without providing personal information to the content provider.

### SUMMARY OF THE INVENTION

Embodiments of the present invention thus provide a device that can intercept data transmitted from one source to another, alter that data based on: who the sender of that data is, who the receiver of that data is, what the data is, and information held in a data store. The device can be a hardware or software device, and can reside at any of a number of locations, from the computer serving content, to the computer receiving content, and including various computers in between these two. The device can intercept and alter data whether that data is sent all at once, or in multiple distinct packets which the device could collect, compile, alter, and sent on.

According to a first aspect of the present invention there is provided apparatus for intercepting data communicated between a sender and a receiver, and conditionally altering that data, the apparatus comprising:

(a) an interception unit, capable of intercepting the communication,

(b) a memory for storing predetermined device settings,

(c) access functionality, associated with the interception unit, operable to access data within the intercepted communication, and

(d) a search and replace unit, associated with both the interception unit and the access functionality, being operable to conditionally alter the intercepted communication in response to the accessed data and the device settings.

Preferably, the access functionality is operable to access a selection from the group consisting of:

(a)sender identification

(b)information about the sender

(c)receiver identification

(d)information about the receiver, and

(e)data type identification.

Preferably, the settings include any one of a group comprising:

(a)information about data types the apparatus may intercept,

(b)users for whom data should be changed.

(c)data to be changed, and

(d)at least one way in which given data is to be changed for at least one user.

Preferably, the interception unit is connectable to intercept data from a computer network.

Preferably, the sender of data and receiver of the data are respectively remotely located.

Preferably, the computer network is a packet based network.

Preferably, the network is a network selected from the group consisting of a

(a) TCP/IP based network

(b) UDP based transmission

(c) ICMP based transmission

(d) IGMP based transmission

(e) TCP based transmission

(f) mobile device based network

(g) Ipv6 based network

(h) Ipv4 based network

(i) SMP based network.

Preferably, the apparatus further comprises a message assembler operable to assemble complete messages from assorted packets.

Preferably, the interception unit is locatable on a sending computer.

Preferably, the search and replace unit is operable to determine a structure of input data and to carry out the alteration within the framework of the determined structure.

Preferably, the structure is a text data structure.

Preferably, the structure defines content text, and tag data.

Preferably, the search and replace unit is operable to selectively do one of adding, altering or deleting data found in a selection from data in and around at least one of the group consisting of:

(a) the text

(b) and tags.

Preferably, the structure is one of a group consisting of:

(a) the SGML format

(b) the HTML format

(c) the XML format

(d) the XHTML format

(e) the WAP format, and

(f) SMTP.

Preferably, the search and replace unit is operable to find a selection from the group consisting of words and tags, and is further operable to do at least one of adding data, deleting data, and altering data that is part of the group of data in and data around that selection.

Preferably, the apparatus is capable of selectively doing at least one of adding, removing and altering data around and in the selection, wherein that data consists of at least one of the group consisting of:

(a)JavaScript

(b)VB Script

(c)Ecma Script

(d)links

(e)color

(g)images

(h)sounds

(j)fonts

(k)Flash

(l)tags

(m)pop-up menus

(n)pop-up windows.

Preferably, the structured data is selected from the group consisting of

(a) image data,

(b) sound data, and

(c) multimedia data.

Preferably, the data alteration consists of altering a selection from the group consisting of:

(a) the resolution of the data and

(b) the compression of the data.

Preferably, the interception unit is locatable on a receiving computer.

Preferably, the search and replace unit is operable to determine a structure of input data and to carry out a replacement within the framework of the determined structure.

Preferably, the structure is a text data structure.

Preferably, the structure defines content text, find tag data.

Preferably, the search and replace unit is operable to selectively do one of adding, altering or deleting data found in a selection from data in and around a selection from the group consisting of:

(a) the text

(b) and tags

Preferably, the structure is selected from the group comprising:

(a) the SGML format

(b) the HTML format

(c) the XML format

(d) the XHTML format

(e) the WAP format, and

(f) SMTP.

Preferably, the search and replace unit is operable to find a selection from the group consisting of words and tags, and is capable of doing at least one of adding data, removing data, and altering data from any of a group comprising data in, and data around the selection,

Preferably the apparatus is capable of carrying out at least one of adding, removing and altering data from any of data in and data around the selection, wherein the data consists of at least one of the group consisting of:

(a)JavaScript

(b)VB Script

(c)Ecma Script

(d)links

(e)color

(h)sounds

(i)multimedia

(j)fonts

(k)Flash

(l)tags

(m)pop-up menus

(n)pop-up windows.

Preferably, the structured data is selected from the group consisting of

(a) image data,

(b) sound data, and

(c) multimedia data.

Preferably, the data alteration consists of altering a selection from the group consisting of:

(a) the resolution of the data and

(b) the compression of the data.

Preferably, the intercepting unit is locatable on an intermediate network mode, between the computer sending the data and the computer receiving the data.

Preferably, the node is a gateway node.

Preferably, the node is a proxy node.

Preferably, the node is an ISP node.

Preferably, the search and replace unit is operable to determine a structure of input data and to carry out a replacement within the framework of the determined structure.

Preferably, the structure is a text data structure.

Preferably, the data structure comprises content text, and tag, data.

Preferably, the search and replace unit is operable to carry out at least one of adding, altering and deleting data found in any one of a group of data in and data around a selection from the group consisting of:

(a) the text and

(b) the tags.

Preferably, the structure is one of a group consisting of:

(a) the SGML format

(b) the HTML format

(c) the XML format

(d) the XHTML format

(e) the WAP format, and

(f) SMTP.

Preferably, the search and replace unit is operable to find a selection from the group consisting of words and tags, and is further operable to do at least one of add data, removing data and altering data, which can be found in and around the selection.

Preferably, the apparatus is capable of selectively doing at least one of adding, removing and altering data around and in the selection, wherein that data consists of a at least one of the group consisting of:

(a)JavaScript,

(b)VB Script,

(c)Ecma Script,

(d)links,

(e)color,

(g)images,

(h)sounds,

(i)multimedia,

(j)fonts,

(k)Flash,

(l)tags,

(m)pop-up menus, and

(n)pop-up windows.

Preferably, the structured data is selected from the group consisting of

(a) image data,

(b) sound data, and

(c) multimedia data.

Preferably, the data alteration consists of altering a selection form the group consisting of:

(a) the resolution of the data, and

(b) the compression of the data.

According to a second aspect of the present invention there is provided a server on a network with

(a) functionality to intercept data being sent,

(b) memory for storing predetermined settings,

(c) access functionality associated with the interception functionality operable to access data within the intercepted communication

(d) a search and replace unit, associated with both the interception unit and the access functionality being operable to conditionally alter the intercepted communication in response to the access data settings.

According to a third aspect of the present invention there is provided a data carrier carrying data usable in combination with a general purpose computer to provide

(a) functionality to intercept data being sent,

(b) memory for storing predetermined settings,

(c) access functionality associated with the interception functionality operable to access data within the intercepted communication

(d) a search and replace unit, associated with both the interception unit and the access functionality being operable to conditionally alter the intercepted communication in response to the access data and settings.

According to a fourth aspect of the present invention there is provided a method for intercepting communications between a sender and a receiver, and conditionally altering the intercepted data comprising:

(a)intercepting the communication,

(b)accessing data from within the intercepted communication,

(c)searching through and conditionally altering the communication and,

(d)forwarding the conditionally altered data on to the intended receiver.

Preferably, the data within the intercepted communication is a selection from the group consisting of:

(a) sender identification,

(b) information about the sender,

(c) receiver identification,

(d) information about the receiver, and

(e) data type information.

Preferably, the method comprises intercepting a communication on a computer network.

Preferably, the sender of data and receiver of the communication are respectively remotely located.

Preferably, the method comprises intercepting a communication from a packet-switched network.

Preferably, the method comprises intercepting communication wherein the network is one of a:

(a) TCP/IP based network,

(b) UDP based transmission,

(c) ICMP based transmission

(d) IGMP based transmission,

(f) mobile device based network,

(g) Ipv6 based network,

(h) Ipv4 based network, and

(i) an SMP based network.

Preferably, the method comprises receiving message parts in separate packets and assembling the packets to form at least one entire message.

Preferably, the method comprises detecting a data structure and altering data within in such a way as to conform to the detected structure.

Preferably, the method comprises altering text data.

Preferably, the text data comprises content text, and tag data.

Preferably, conditionally altering comprises adding data around a selection from the text and the tags.

Preferably, the structure is any one of a selection from the group consisting of

(a) the SGML format

(b) the HTML format

(c) the XML format

(d) the XHTML format

(e) the WAP format, and

(f) SMTP.

Preferably, the searching through and conditionally altering comprises finding a selection from the group consisting of words and tags, and selectively carrying out at least one of adding, removing and altering data which is at least one of in, and data around the selection.

Preferably, the data is selected from the group consisting of:

(a)JavaScript

(b)VB Script

(c)Ecma Script

(d)links

(e)color

(g)images

(h)sounds

(i)multimedia

(i)fonts

(k)Flash

(l)tags

(m)pop-up menus

(n)pop-up windows.

Preferably, the step of conditionally altering comprises altering the communication in accordance with predetermined settings.

Preferably, the step of conditionally altering comprises altering the communication in accordance with the accessed data.

Preferably, the conditionally altering, comprises altering the communication in accordance with the accessed data taken together with predetermined settings.

Preferably, the structured data is selected from the group consisting of

(a) image data,

(b) sound data, sound

(c) multimedia data.

Preferably, the data alteration consists of altering a selection form the group consisting of:

(a) the resolution of the data, and

(b) the compression of the data

Several objects and advantages of the present embodiment are:

(a) allowing advertising to be more fully integrated into the users browsing experience

(b) allowing advertising to be incorporated in existing documents without having to have those document manually changed

(c) allowing accurately targeted advertising to be seen by a user

(d) allowing elements of a document that change regularly to be updated for any, page, static, or dynamically generated, without the page having to be manually updated

(e) allowing for individually tailored content to be displayed for a user, even if it is the first time the user is visiting a particular site

(f) allowing the above advantages without necessarily having to compromise a users privacy

Further objects and advantage are to provide for dynamic content without necessarily having to use the content servers resources to generate the dynamic contest, to allow machines other than the content server to add content to the pages being viewed by the user, and to allow a greater information pool to go into generating the dynamic content. Further objects and advantages will become apparent from a consideration of the ensuing description and drawings.

### BRIEF DESCRIPTION OF THE DRAWINGS

For a better understanding of the invention and to show how the same may be carried into effect, reference will now be made, purely by way of example to the accompanying drawings.

With specific reference to the drawings in detail, it is stressed that the particulars shown are by way of example and for purposes of illustrative discussion of the preferred embodiments of the invention only, and are presented in the cause of providing what is believed to be the most useful and readily understood description of the principles and conceptual aspects of the invention. In this regard, no attempt is made to show the structural details of the invention in more detail than is necessary for a fundamental understanding of the invention. The description taken with the drawings making apparent to those skilled in the art how several forms of the invention may be embodied in practice. In the accompanying drawings:

FIGS. 1a and 1b are schematic diagrams showing a first preferred embodiment of the present inventors embodiment. Both show a general model of how the device works. The device intercepts the data going from a sender to a receiver. The device can alter that data, and send that data on to the receiver. FIG. 1a shows the device altering data based on an external data store, and FIG. 1b shows the device altering data based on a data store internal to the device

FIG. 2 is a more detailed view of a data store 44 in FIG. 1, showing some of the possible data the embodiment of FIG. 1 may have access to in determining what data to alter and how to alter that data

FIG. 3 is a more detailed overview of the operation of the embodiment of FIG. 1, having access to the data of FIG. 2

FIG. 4 is a generalized flow chart showing the process of altering data, according to an embodiment of the present invention.

FIG. 5 is a simplified flow chart of an embodiment of the present invention.

FIG. 6 is a simplified flow chart of an embodiment of the present invention that accepts and recognizes the TCP/IP protocol, and determines if the sender is a sender the device has been set to alter data from.

FIG. 7 is a continuation of the flow chart of the device of FIG. 6.

FIG. 8 is a simplified flow chart showing HTML page alteration according to a preferred embodiment of the present invention.

FIG. 9 is a simplified flow chart showing bow the device may search through a directory structure, and find files and data in those files, for alteration.

FIG. 10 is a simplified flow chart showing operation of the device as it may be implemented on a receiver, where the receiver would do most of the work in collecting and assembling the packets, and the device world only need to alter data, based on the data store.

FIG. 11 is a simplified flow chart showing operation of the device as it may be implemented on a machine sending the data.

FIG. 12 is a simplified flow chart which determines if the packet data is in the correct protocol for alteration, and is from a sender the device is set to alter data from, on any network node.

FIG. 13 is a simplified flow chart showing how the unit may modify individual packet, coven when the unit is not given an entire object, only individual packets thereof.

### DESCRIPTION OF THE PREFERRED EMBODIMENTS

Before explaining at least one embodiment of the invention in detail, it is to be understood that the invention is not limited in its application to the details of construction and the arrangement of the components set forth in the following description or in the illustrated drawings. The invention is applicable to other embodiments or of being practiced or carried out in various ways. Also it is to be understood that the phraseology and terminology employed herein is for the purpose of description and should not be viewed as limiting.

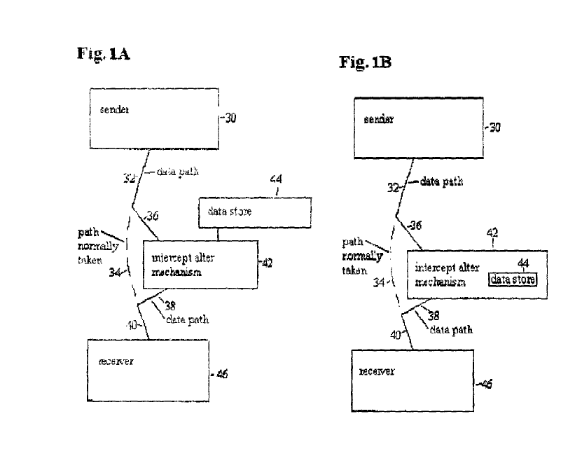

Reference is now made to FIG. 1 which is a generalized block diagram showing a first preferred embodiment of the present invention incorporated within a computer link. A sender of data (the Sender) 30 that normally communicates directly with a receiver of data (the Receiver) 46 via a channel 32,34,40 has its communications intercepted by functionality to intercept the communication and conditionally alter the data, hereafter called the intercept-alter device. In FIG. 1a the intercept-alter device 42 has access to an external data store 44. Depending on the data store 44, the intercept-alter device may alter the data and then forward the data on to the receiver. In FIG. 1b the data store is internal to the intercept-alter device. One skilled in the art may see how the data store may be completely internal to the intercept-alter device, completely external to the intercept-alter device, or have one or more data stores that are internal, and one or more data stores that are external.

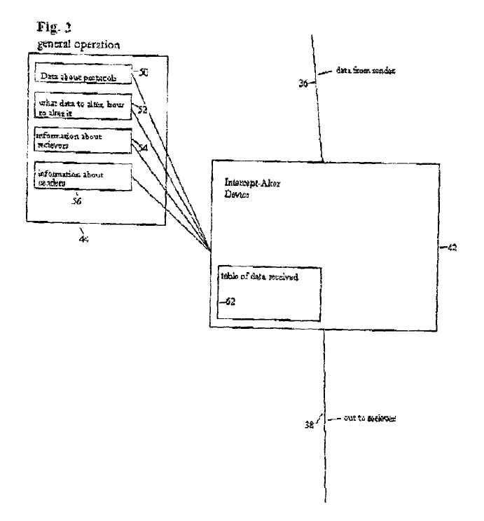

Reference is now made to FIG. 2, which is a generalized block diagram showing the embodiment of FIG. 1, and in particular, showing types of information that nay be used in the alteration process. The intercept-alter device 42 may be connected to a data store of some sort 44. The data store 44 may contain information about:

(a) protocols the intercept-alter device recognizes and can alter 50, a protocol table,

(b) information about data the intercept-alter device may receive, what data to alter, and how to alter that data 52, a data information table,

(c) information about various receivers of data that is used in determining how to alter data for those receivers, and which receivers to alter data for 54, a receiver's table,

(d) and information about the senders of data, how to alter data from those senders of data, and which of those senders to alter data from 56, a sender's table.

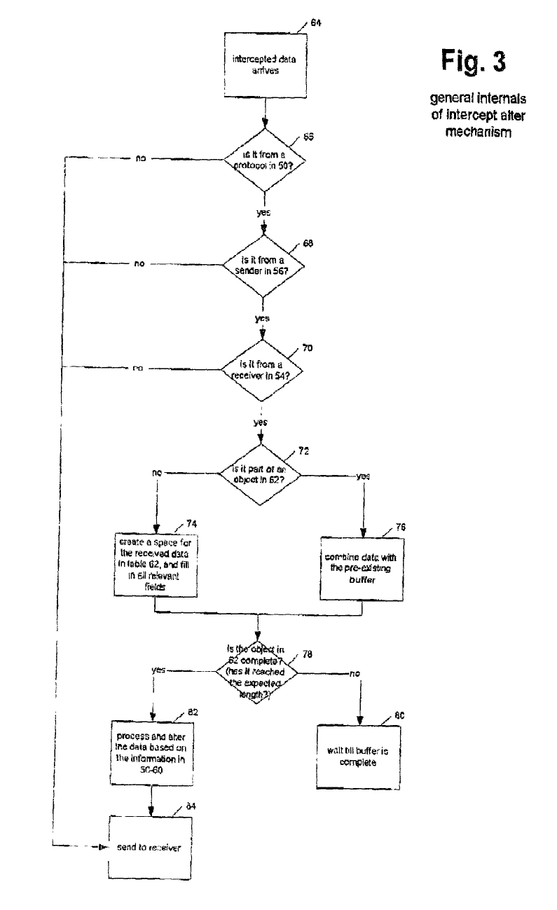

The intercept-alter device has access to the data the sender is sending, which comes in on a communication channel 36. The intercept alter device may have access to an internal table of previously received data 62, a previously received data table, which may include information about the destination address, possible on IP address of 32 bits, possibly any other address (a System V name, a Corba Name, a 48 bit IP address, or any other address), a destination port, a flag indicating if the protocol is HTTP, the size of the expected incoming data, and a pointer to the buffer containing the incoming data. The previously received data table may contain other information about the previously received data as is necessary for the device. The intercept-alter device keeps this table in the event that the intercept alter device needs to compile a complete object for processing. After the intercept-alter device has done whatever the intercept-alter device has to do to the intercepted data (see FIGS. 3-13) the intercept-alter device may forward the processed intercepted data on to the original receiver via a data channel 38. It should be clear that the intercepted data may or may nor have been altered.

In FIG. 2 the data store 44 is shown to be external to the intercept-alter device, but it could easily be internal to the intercept-alter device. In this diagram, there is only one data store containing information the intercept-alter device 42 may reference, but there could easily be implementations where the intercept-alter device 42 has access to multiple data stores that contained information. It should be clear that the data store may have information relating the data to the sender or receiver as well. That the data information table may have data relating changes to particular senders or receivers.

Reference is now made to FIG. 3 which is a simplified flow chart of a first embodiment of the present invention, showing the processing of intercepted data by the intercept-alter device 42. Upon initially intercepting data 64, the intercept-alter device checks to see if the data is from a protocol the intercept-alter device recognizes 66, i.e. if the data is in a protocol in the protocol table 50. It should be seen that if the intercept-alter device only recognizes one protocol or if the intercept-alter device recognizes all protocols, step 66 may not be necessary. If the data that was intercepted is not from a protocol the intercept-alter device recognizes 66, the intercept-alter device sends the data directly on to the receiver 84 without further processing.

If the intercepted data is from a protocol the intercept-alter device recognizes 66, the intercept-alter device checks if the data is from a sender the intercept-alter device should alter data from 68 i.e. if the sender of the data is in the sender's table 56. If the intercept-alter device is set up to alter data from only one sender, from all senders, or if the intercept alter device resides on the server, step 68 may be skipped. If the data is not from a sender in the sender's table 56 the intercept-alter device forwards the data on to the receiver 84 without further processing.

If the sender is a sender the intercept-alter device has been instructed to alter data from, i.e. is in the senders table 56, the intercept-alter device checks to see if the data is going to a receiver the intercept-alter device alters data for 70 i.e. if the receiver in the receiver's table 54. If the intercept-alter device is set up to alter data for only one receiver, for all receivers, or if the intercept alter device is residing on the client, step 70 may be skipped. If the data is not to a receiver the intercept-alter device is set up to alter data for, the intercept-alter device sends the data directly onto the receiver 84 without further processing.

If the data is going to a receiver the intercept-alter device is set up to alter data for, the intercept-alter device checks if the data it received is a sub-part of a larger object, where the intercept alter device needs to accumulate the entire object for processing. If the intercept-alter device is guaranteed, to have obtained an entire object, or the intercept-alter device can process partial objects, the intercept-alter device may skip steps 72 through 80, and immediately go to processing the data, step 82. If the intercept-alter device needs to accumulate an entire object before pressing that object and the device is not guaranteed to receive a complete object each time, the intercept-alter device checks if the data is part of a previously received object 72, i.e. if there is an entry for this data object in the table of previously received data 62. If the data is part of some object that the intercept-alter device has already received data from, the intercept-alter device combines the new data with the previously received data 76 to reconstruct the larger object. If the data is not part of a previously received data object, the intercept-alter device creates a new entry in the table of previously received data 62 and fills in the information the intercept-alter device has about the received data 74, possibly including, but not limited to:

(a) who the sender is,

(b) who the receiver is,

(c) what protocol the data is in,

(d) identification information relating to what data object the data is from,

(e) what the data is.

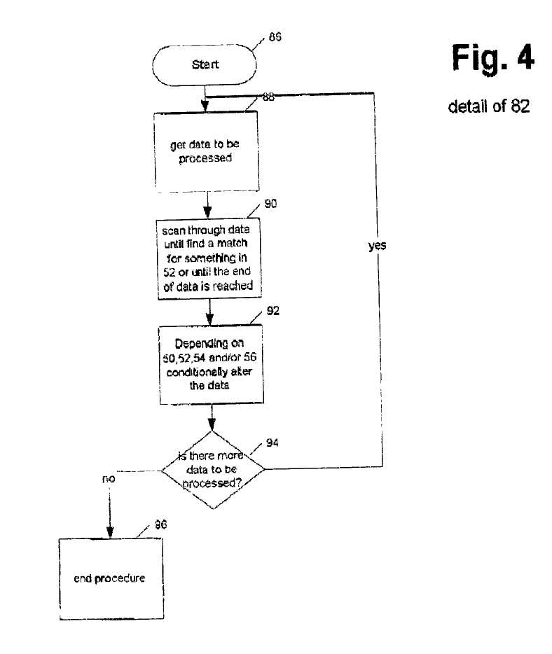

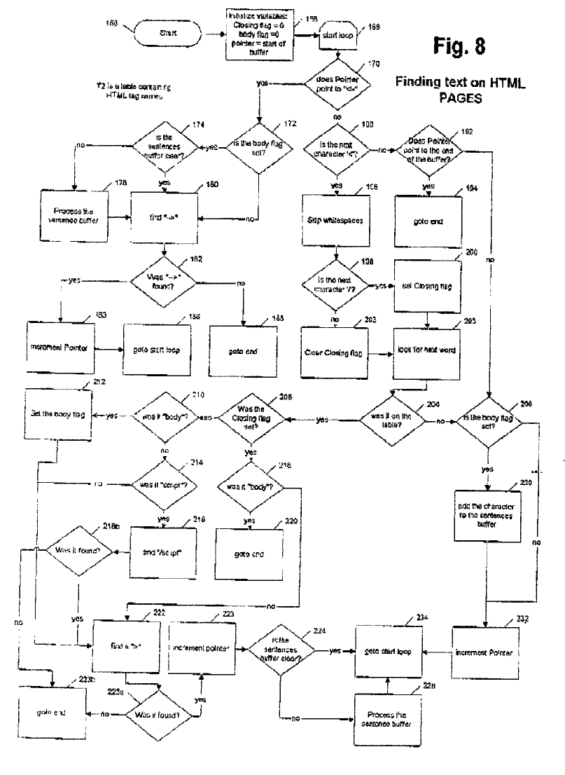

After either creating space for the new data, step 74 or combining the data with the previously received data, step 76, the intercept-alter device checks to see if the object it has been manipulating in the previously received data table is complete or not 78. If the object is not complete, the intercept-alter device waits for more data 80, until it has a complete object. If the object is complete, the intercept-alter device processes the data, and alters it 82 as will be seen in greater detail with respect to FIGS. 4 and 8. After processing the data, the intercept-alter device sends the altered data on to the receiver 84.

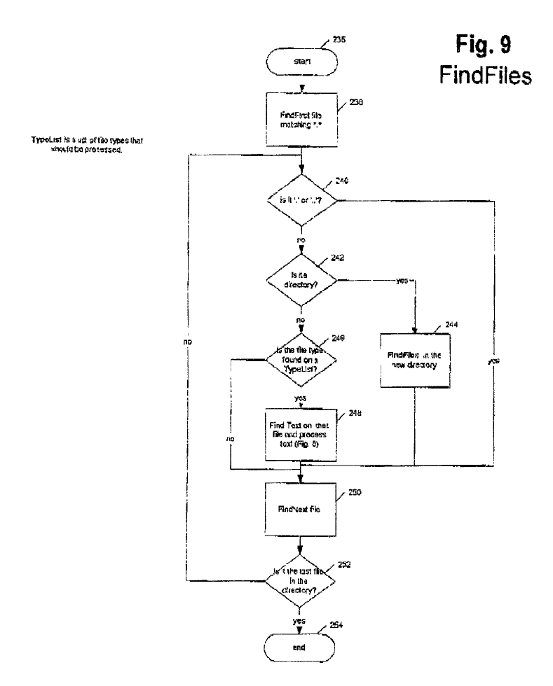

Reference is now made to FIG. 4, which is a flow chart showing how a device according to a preferred embodiment of the present invention may alter data. The intercept-alter device obtains data capable of being processed 88, be it from a determination the mechanism has made, possibly from step 82 in FIG. 3, being handed a file from step 248 in FIG. 9 or any of a variety of other ways. The intercept-alter device then scans through the data until it finds data the intercept-alter device should alter 90. Determining what the intercept-alter device should alter may be done by running the data under image recognition software, by semantic based software that recognizes meaning, or by simply finding matches between small sections of data (like words) in the data object and in the data store about data to be altered 52 or by some other data recognition functionality. The data store may be organized to have specific words that the intercept alter-device could recognize and replace with pre-specified words or character streams, or the intercept-alter device may use dynamic techniques in its recognition and replacement functionality. Depending on the information available to the intercept-alter device (possibly consisting of, but not limited to, information about the sender, who the sender is, information about the receiver, who the receiver is, what the data is, what information the intercept-alter device can access about the data, what protocols the data is in, what information, the intercept-alter device has about those protocols) the intercept-alter device alters the data 92. The intercept-alter device then checks if the intercept-alter device has reached the end of the data 94. If the intercept-alter device has reached the end of the data, it ends the procedure 96. Otherwise, the intercept-alter device continues to scan through the data (the intercept-alter device returns to 88).

FIGS. 1-4 show abstract implementations of the intercept-alter device. The intercept-alter device 42 is located between a sender of information 30 and a receiver of information 46. The intercept-alter device intercepts data passed between the sender 30 and the receiver 46. The intercept-alter device may have access to many different pieces of information 44. The information may be stored internally to the intercept-alter device, or stored externally, and may include (FIG. 2):

a. who the sender of the data is,

b. information about the sender, 56

c. who the receiver of the data is,

d. information about the receiver, 54

e. what the data is,

f. what protocols send the data, and what format the data is in

g. which protocols and formats the intercept-alter device is to alter 50

h. information about what data to alter, 52

i. how to alter it, 52

Some of the above information may be part of the data being sent (for example: what the data is) and some may be other information the intercept-alter device has access to, either from an internal data store, or from some external source the intercept-alter device has access to. As examples, the device may keep a completely internal data store about a single user which the intercept alter device may alter data for. The intercept-alter device may have access to a central repository, external to the intercept-alter device with similar information. The device may have data that determines changes only for particular receivers. The intercept alter device may have data that determines changes only from particular senders.

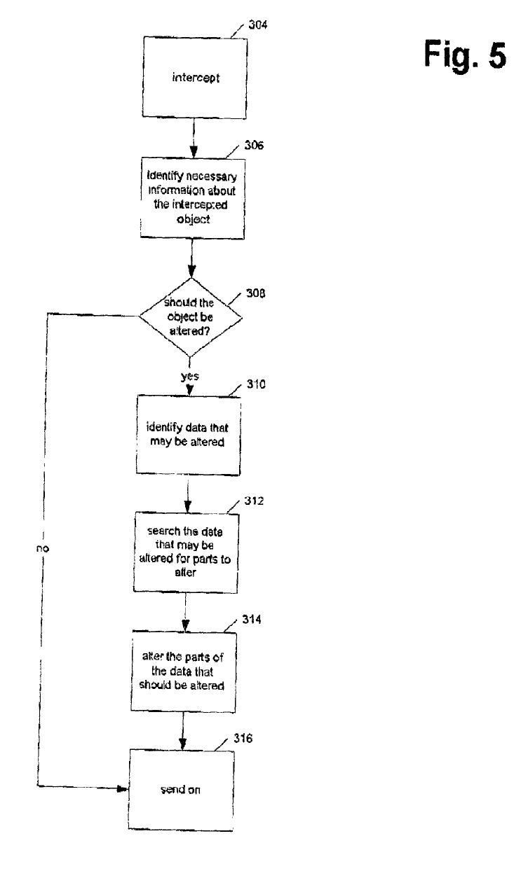

A preferred embodiment of the invention is described with reference to FIGS. 5-9. The skilled person will appreciate that, wherever reference is made to HTML, reference is intended to HTML or variations thereof however generated, and may include HTML obtained directly from a static page, generated on the fly by a JSP, an ASP, a JHTML page, DHTML, XHTML, or an XML repository, by way of example.

Reference is now made to FIG. 5 which is a simplified flowchart of a preferred embodiment of the present invention. The intercept-alter device intercepts a packet sent from the sender to the receiver 304. The intercept-alter device finds the header information of the packet 306. If the packet, and its data are not of a type the intercept-alter device alters 308(if it not any of TCP/IP, TCP, HTTP, and HTML, or is not from a sender the intercept-alter device is set to alter data from, or is not to a receiver the intercept-alter device is set to alter data for) the intercept-alter device sends the packet straight on to the receiver 316. If the packet and packet data are of a type the intercept-alter device alters (It is TCP/IP, TCP, HTTP, and HTML, and is from a sender and receiver the intercept-alter device alters data from and for), the intercept-alter device identifies the data area 310, i.e., finds the body tag, searches for text data to be altered 312 and processes the text 314. HTML consists of text segments, and formatting information. The formatting information is in tags, specific words that are surrounded by the characters “<” and “>”. The formatting information may be information about the spacing of words, links to other web sites, or a wide variety of other data, including programs that alter the web page, The mechanism may find particular words in the text, and replace those words with some combination of words and tags. The intercept-alter device preferably sends the data, with the replacements, on to the receiver 316.

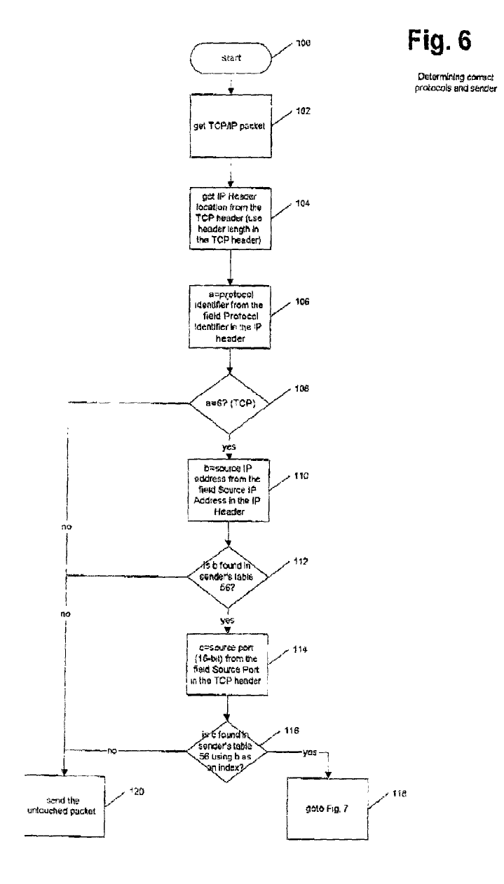

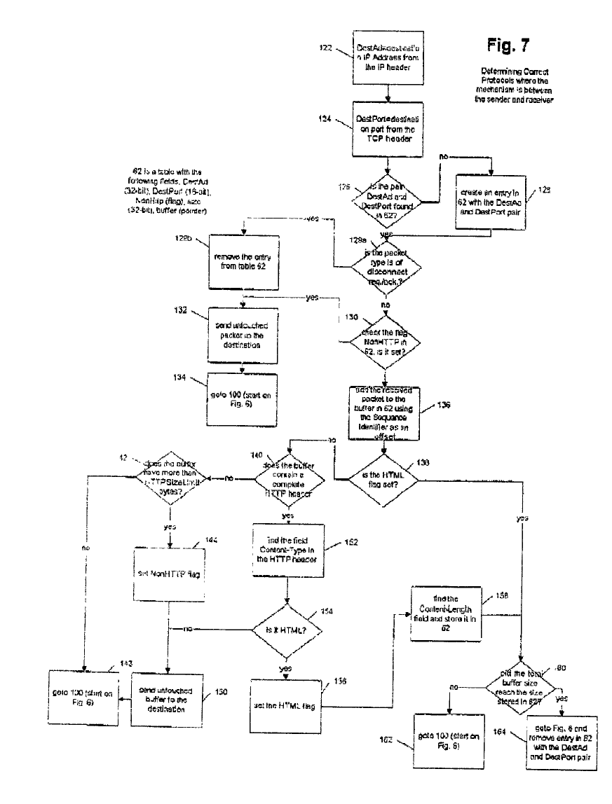

Reference is now made to FIG. 6 which is a simplified flow chart showing a preferred embodiment of the present invention for recognizing and processing data using the TCP/IP protocol. In the embodiment of FIG. 6, the intercept-alter device intercepts a packet 102 between the sender and receiver (possible locations of the intercept-alter device include but are not limited to an ISP, a gateway, a content distribution network, a proxy server, and any other network or internet node). The intercept-alter device determines the IP header location from the TCP header 104. The intercept-alter device identifies from the header information which protocol is sending the packet 106, and determines if that protocol is one the intercept-alter device accepts 108, in this case just TCP/IP. If the packet is not from a protocol the intercept-alter device accepts, the intercept-alter device sends the packet on to the receiver untouched 120. Otherwise, the intercept-alter device determines the sender from the Its TCP/IP headers 110. If the sender cannot be matched with a sender in the sender's table 56,112 the intercept-alter device sends the packet on untouched 120. If the sender is matched in the sender's table, the intercept-alter device checks which port of the sender the data comes from 114. The intercept-alter device checks if the packet is from a port that the intercept-alter device is set to alter data from 116. If the port is not recognized the intercept-alter device sends the data on untouched 120. Otherwise the intercept-alter device continues with the packet processing 118 as described now with respect to FIG. 7.

Reference is now made to FIG. 7 which is a simplified flow chart showing a continuation of the process of FIG. 6.

The intercept-alter device has a table of destination addresses and ports that it has received packets for, the previously received data table 62. For each entry in the previously received data table 62 the intercept-alter device has a pointer to a buffer containing all the data in previous packets for that receiver, and a field for indicating how large the data is.

The intercept-alter device looks at the IP address of the receiver of the data 122. The intercept-alter device looks at the port that the packet is going to 124. If the receivers IP address and port number are not already in the intercept-alter device's previously received data table 62, 126, the intercept-alter device creates an entry for that receiver 128 in the previously received data table, and inserts the received data into the previously received data table 62. If the packet indicates that the receiver is either requesting a disconnect or acknowledging a disconnect 129a, the intercept-alter device removes the specific entry with this destination address and destination port in table 62 129b, sends the packet onto the receiver untouched 132, and waits for additional packets FIG. 6, 100. The intercept-alter device checks if the already recognized packets going to the receiver and port are, or are not, from a protocol the intercept-alter device deals with (in this case HTTP) 130. If the packet is not from a protocol the intercept-alter device deals with, the intercept-alter device sends the packet on untouched 132, and returns to 100 in FIG. 6 134. If the packet is HTTP (non-HTTP flag is 0), the intercept-alter device appends the packet to the end of the previously received packet(s) 136 in the previously received data table 62. The intercept-alter device checks if the HTML flag is set 138. If the HTML flag is set, and the buffer size is equal to the expected size 160, then the intercept-alter device processes the HTML (FIG. 8), and removes the specific entry with this destination address and destination port in table 62 164. If the HTML flag is set 138, and the buffer is not equal to the expected size 160, the intercept-alter device waits for additional packets 162.

If the HTML flag is not set, and the buffer contains a complete HTTP header 140, the intercept-alter device finds the field, content-type in the HTTP header 152. If the content type is HTML 154, the intercept-alter device sets the HTML flag 156, finds the content length, and stores the data in a buffer 158 in the table of previously received data 62. If the buffer is the expected size 160, the intercept-alter device processes the buffer (FIG. 8) 164. Otherwise, the intercept-alter device waits for additional packets 162, FIG. 6, 100.

If the HTML flag is not set 138, and the packet does not contain an HTTP header 140, the intercept-alter device checks if the buffer has more than a pre-determined number of bytes 142. If the buffer does not have more than a pre-determined number of bytes, and the HTTP header is incomplete or missing, the intercept-alter device waits for a complete HTTP header (waits for additional packets) 143. If the buffer has more than a pre-determined number of bytes, the intercept-alter device sets the NonHTTP flag 144, sends the buffer on to the destination untouched 150, and waits for additional packets 143, FIG. 6, 100.

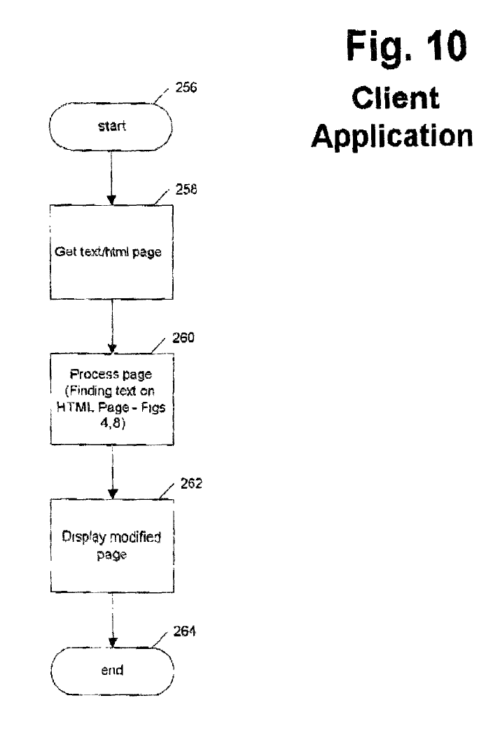

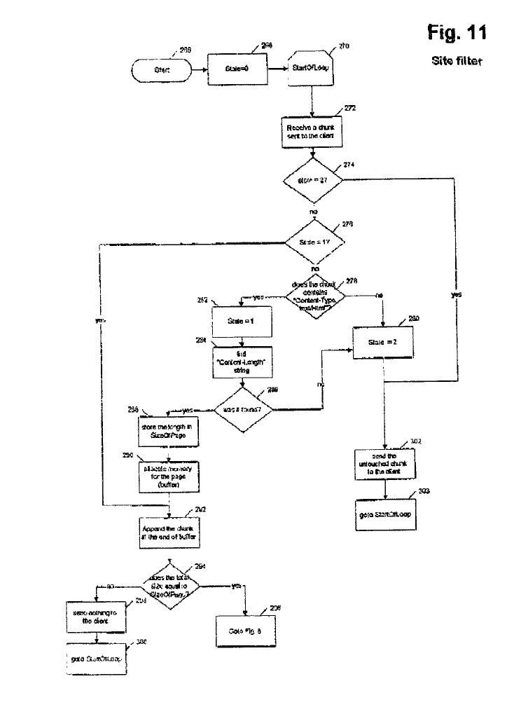

Reference is now made to FIG. 8, which is a simplified flow chart of how the intercept-alter device may alter HTML pages. The intercept-alter device assumes it has either a complete HTML page to deal with at this stage, and was called from FIG. 6, FIG. 7, FIG. 9, FIG. 10 or FIG. 11. One skilled in the art will see how when the process is ended in the middle by not finding certain expected results (not finding a closing tag, or an /script, for example), the intercept-alter device may send on either the modified, or unmodified version of what it had received.

The intercept-alter device starts processing a page 166. The intercept-alter device initializes 3 internal variables, it sets a closing flag to false (0), a body flag to false (0), and sets a pointer to the start of the HTML page 168. The intercept alter device then enters into a loop 169.

At the start of the loop, the intercept-alter device checks if the pointer is pointing to the sequence of characters indicating the beginning of a comment: “←” 170.

If the pointer is currently indicating the beginning of a comment, the intercept-alter device checks if the body flag is set to true (1) 172. If the body flag is set, the intercept-alter device checks if the sentence buffer is clear 174. If the sentence buffer is clear, the intercept-alter device scans through the HTML page until it finds an end comment 180 “->”. If the sentence buffer is non-empty, the intercept-alter device processes the sentence buffer, 178, and searches for an end comment 180. Processing of the sentence buffer consists of finding terms keywords or phrases in the sentence buffers, altering those terms, keywords or phrases, and adding a prefix and suffix to those terms, keywords and phrases. The prefix and suffix may be part of an HTML tag, and may have links, images, formatting information, Scripts, and other effects.

The intercept-alter device checks if it has found an end comment 182. If it has found an end comment, the intercept-alter device increments the pointer to just past that end comment 183 and goes back to the start of the loop 186. If no end comment was found, then the intercept-alter device stops processing the current page 188.

If the pointer is not pointing to the beginning of a comment, the intercept-alter device checks if the next character is the start of a tag, i.e. If the next character is “<” 190. If the intercept-alter device is pointing to the start of a tag, the intercept-alter device skips any white-space 196, until it finds a character. If the first character the intercept-alter device sees is a forward slash 198 “/”, indicating a closing tag, the intercept-alter device sets the closing flag 200, and finds the next word after the forward slash 203. If the next letter is not a forward slash 198, the intercept-alter device clears the closing flag 202, and finds the next word 203.

The intercept-alter device checks to see if the next word is on a list of legal HTML tags 204 that list possibly found in the data information table 52, or the protocols table 50. If the word is on the intercept-alter devices list of tags, the intercept-alter device checks if the closing flag is set 208. If the closing flag is set, the intercept-alter device checks if the next word is “body” 216 indicating the end of the document. If the next word is “body”, the intercept-alter device is finished processing the current page 220. If the closing flag is not set, the intercept-alter device checks if the next word is “body” 210. If the next word is “body” the intercept-alter device sets the body flag 212. If the next word is not body the intercept-alter device checks if the next word is “script” indicating an embedded program, which the present embodiment does not alter 214. If the next word is “script” the intercept-alter device scans until it finds “/script”, indicating the end of the program imbedded in the HTML 218, 219b. If the closing “/script” was not found, the intercept alter device stops processing the page 223b.

After the intercept-alter device has either

(a) set the body flag 212, or

(b) found the closing flag set, when the closing flag does not close a “body” 216,

(c) found “/script” 218, or

(d) failed to find a script 214,

the intercept-alter device scans the current document until it finds a “>” 222. The intercept alter device checks to see if the “>” was found 223a. If “>” was not found, the intercept-alter device stops the page processing 223b. If “>” was found The intercept-alter device increments the pointer to just after the “>” 223. The intercept-alter device checks if the sentence buffer is clear 224, and if it is, goes back to the start of the loop 234. If the sentence buffer is not clear, the intercept-alter device processes the sentence buffer 228, and then returns to the start of the loop 234.

If, having found the next word after the “<”, the word not being on the list of tags 204, then the device checks whether the body flag has been set 206.

If the character the intercept-alter device is looking at, at the start of the loop 190, is not “<”, the intercept-alter device checks if the pointer is pointing to the end of the buffer 192. If the pointer is pointing to the end of the buffer, the intercept-alter device ends the procedure 194. Otherwise, the intercept-alter device checks if the body flag is set 206.

If the body flag is set, the intercept-alter device adds the current character to the sentence buffer 230.

The intercept-alter device then preferably increments the pointer 232, and returns to the start of the loop 234.

One skilled in the art will see that in this embodiment the device will never alter data that is found within HTML tags. It should be seen by one skilled in the art that this is not limiting, that the device may alter data inside of tags as well. This may be accomplished by any number of means, including by having step 203 check the contents of the tag, and then alter the contents of the tag.

Reference is now made to FIG. 9 which is a simplified flow chart showing how the intercept-alter device may be used to scan a directory structure, find files in those directories to be altered, and alter those files.

In FIG. 9 the files are assumed to be static files of a type the intercept alter device is set to alter.

The intercept-alter device preferably finds a file, on the given directory structure, matching a type the intercept alter device is set to alter 238. Preferably, the device searches for all files and then matches the file name or file type against the predetermined settings. The intercept alter device checks the file type 240. If that file is a directory 242, the intercept-alter device recursively calls itself on that directory 244.

If that file is an actual file, the intercept-alter device checks to see if that file is of a format that the intercept-alter device handles 246. If the file is of a type that the intercept-alter device handles, the intercept-alter device processes the file, c.f. FIGS. 4. 8 248, in either case, that is to say if it is or isn't a type the intercept-alter device handles, the intercept-alter device searches for the next file in the directory 250. If it was the last file in the directory 252, the process ends 254. Otherwise processing returns to step 240.

Reference is now made to FIG. 10 which is a simplified flow chart showing a preferred embodiment of how the intercept-alter device may operate on a receiver's machine. The intercept-alter device sits on a receiver's machine. After the receiver has received an entire data object 256 the computer checks that data object. If it is in a format the intercept-alter device is set to alter 258 (in this case HTML) the intercept-alter device checks it, alters it 260, FIGS. 4, 8, and sends the data onto whatever program is supposed to use it 262.

Reference is now made to FIG. 11 which is a simplified flow chart illustrating a preferred embodiment of how the device may work on a computer serving an HTML page.

When the computer is about to send a piece of data onto a new receiver, the intercept-alter device preferably creates a new instance of itself specifically for this data object (before 266) that intercepts the data being sent, and handles all further communication for that particular data object, regardless of how many pieces or packets this data object is sent in. The new instance of the intercept-alter device initially sets itself to a state indicating it has not received any data 268. The intercept alter device then enters into a loop 270. The intercept-alter device receives a piece of data 272, and checks if the data object or part being sent is in a format the intercept-alter device does not accept 274. In this case the device accepts only HTML. If the format is not of an acceptable type, then the new instance sends the data object or part on as well 274, 302. The intercept alter mechanism checks to see if the object is known to be of a type the intercept-alter mechanism accepts 276. If the data object or part is in a format that the intercept-alter device handles (HTML in this case), then in the case of an object part the new instance appends the part to any previously received part 292. If this is the first part for the current object, the process checks to see if the format of the data is a format that the intercept-alter device is supposed to alter 278. If the data object is not in a format the intercept alter device is set to handle, the new instance marks the object as not being in a format the intercept-alter device recognizes, the device indicates that this instance does not deal with data the device accepts (this instance alters it's own state) 280 and sends the data on untouched 302 and returns to the start of the loop 303.

If the data is a format the intercept-alter device handles, the new instance marks it as such 282, checks to see the expected data length 284, checks if the expected length was found 286. If the expected data length was found, the intercept alter device stores that length 288, creates a buffer with the correct data length 290, and puts the packet into the newly created buffer 292 to be joined by later to-be-received parts of the same object. If the expected data length was not found, the intercept alter device sets its state to indicate it is dealing with a format the device does not handle 280 (in this case, invalid HTML) and continues from step 280 on.

If the data buffer for the current client and port destination is completely 294, the process processes the data object looking for data the intercept-alter device is set to alter, and alters that data according to its (the intercept-alter device's) settings 296.

Otherwise, if the object is not complete, the new instance waits for new object parts 298 300.

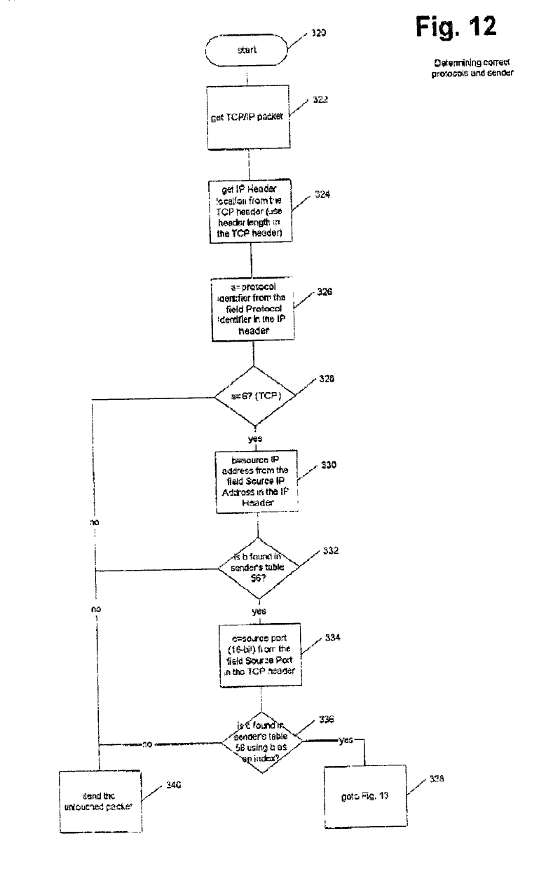

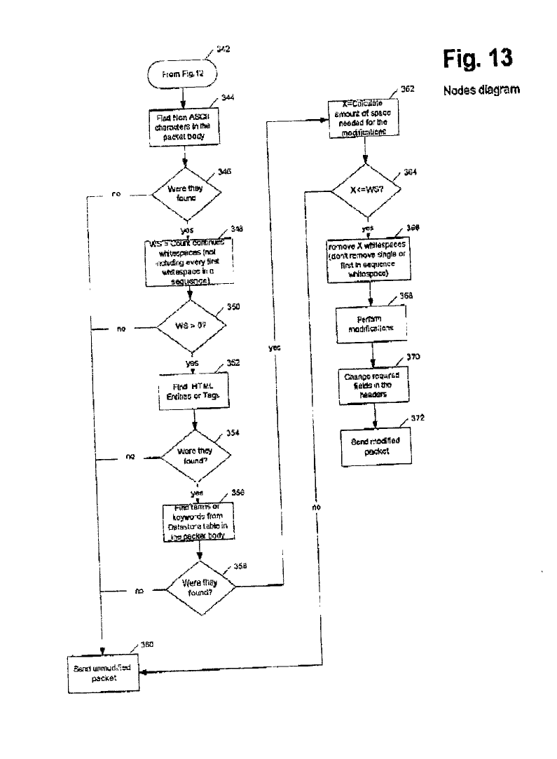

Reference is now made to FIG. 12 which is a simplified flow chart showing a preferred embodiment of the present invention for recognizing and processing data using the TCP/IP protocol on any network node, even a n node not guaranteed to receive an entire HTML document, but only individual packets thereof. In the embodiment of FIG. 12, the intercept-alter device intercepts a packet 322 between the sender and receiver (possible locations of the intercept-alter device include but are not limited to an ISP, a gateway, a content distribution network, a proxy server, and any other network or internet node). The intercept-alter device determines the IP header location from the TCP header 324. The intercept-alter device identifies from the header information which protocol is sending the packet 326, and determines if that protocol is one the intercept-alter device accepts 328, in this case just TCP/IP. If the packet is not from a protocol the intercept-alter device accepts, the intercept-alter device sends the packet on to the receiver untouched 340. Otherwise, the intercept-alter device determines the sender from the TCP/IP headers 330. If the sender cannot be matched with a sender in the sender's table 56 the intercept-alter device sends the packet on untouched 340. The intercept alter device checks if the sender is matched in the sender's table 332, if the sender is not in the senders table, the intercept-alter device sends the packet on untouched 340. If the sender is matched in the senders table, the intercept-alter device checks which port of the sender the data comes from 334. The intercept-alter device checks if the packet is from a port that the intercept-alter device is set to alter data from 336. If the port is not recognized the intercept-alter device sends the data on untouched 340. Otherwise the intercept-alter device continues with the packet processing 338 as described now with respect to FIG. 13.

Reference is now made to FIG. 13, which is a simplified flow chart of packet processing as it may occur on any network node regardless of if the particular node the present embodiment resides on is guaranteed to receive an entire document. The intercept alter device scans through the entire packet, searching for non-ASCII characters 344. If there are any non-ASCII characters 346, the device sends the packet on unmodified 360. If there are no non-ASCII characters, the device determines the total number of extra white-space 348. The device checks if there is more than 0 extra white-spaces 350. If there is no extra white-space the intercept alter device sends the packet on untouched 360. If there is any extra white-space in the packet, the intercept alter device searches for any indicators that the packet is an HTML packet (HTML tags, HTML headers . . . ) 352. If none were found 354 the intercept alter device sends the packet on untouched 360. If HTML indicators were found, the intercept alter device searches through the packet, finding terms or keywords from a data store 52 that the device is set to alter 356. If none were found 358, the device sends the packet on untouched 360. If there are such terms or keywords the device is set to alter 358, the device calculates the amount of space needed for the modifications 362. If there is insufficient white-space for even one modification 364, the device sends the packet on untouched 360. Otherwise, the device removes the amount of white-space needed for the modification 366, performs the modification 368, changes whatever fields are necessary to be changes in the header of the packet, 370, and sends the modified packet on to the receiver 372.

It will be noted by one skilled in the art that if there is no extra white-space, in this embodiment, the device sends the data on untouched. This is not necessarily so, the device may be set to make changes which would increase the extra white-space in the packet, for example, by deleting certain words, or exchanging certain words with smaller words. If this device were set to do this, step 350 may be skipped, and the device may also alter packets with no extra white-space. It will be further noted that while this diagram shows how to do alterations on individual packet of HTML documents, this method would work for any text based packet, and with necessary protocol information, for any packet, with a protocol that the intercept alter device may alter.

### Examples

An internet based content server (a web server) may have thousands or hundreds of thousands of static web pages. Some of those pages may have links to a given other internet site. Assuming that the other Internet site's location has changed, in the normal course of events, the web server operator would have to go through all his documents and find the links, and change them. Automated tools exist that will make this job faster, but the Web-Server may have to tell those tools which directories to scan. If the content is in different locations, it may be difficult to remember where all the references to be changed are. Using a device according to the present embodiments, all the web-server would have to do would be to make a single entry in a data information table 52, and automatically any place where the original, now changed site reference appears, may be automatically replaced by a reference to the new site. It is pointed out that in the case where the intercept-alter device is installed on the server itself there is no need to have the intercept-alter device check the source or the destination of the data. If the intercept-alter device is on an ISP, then the intercept-alter device may have to be configured to check references from only the particular web server in question to make alterations to references to the old site. If the ISP has the intercept-alter device in place, then any servers that the ISP provides service to could have their own data information table 52. The same process may work if a Web-Server has many images imbedded in its pages, and the image directories are moved. Changing names of files that have moved in a directory structure can require time to find and replace all the references, but with the present embodiments, all that is required is putting an entry, for each image, in the data information table 52 indicating the alteration to be made.

An article has a reference to a hand held computing device. The intercept-alter device intercepts the article somewhere on the way to a user. The intercept-alter device recognizes hand held computing as something it may alter, either because a corresponding setting has been manually placed in its data information table 52, or because it has a semantic based unit that recognizes references to hand held computing. References to a product in an article are likely to be a good place to advertise that product. A free ISP that gives away Internet service, may, instead of taking up space on the end-users screen, wish to have the intercept-alter device embed a link to a hand held computing device store. If the user clicks on the link in the article, that “click through” may thus be used to obtain benefit for the ISP.

If the intercept-alter device is located on the users machine, then the intercept-alter device may assemble data about the user, and the user's surfing habits. The intercept-alter device, based on that user's surfing habits, may choose if the link to create would be to a page advertising a PalmPilot, a Windows CE machine, a Linux-based system or a BSD based hand held computing device. For instance: if the device had created a profile of the user indicating technical preferences, the intercept alter device may create a link to a Linux, or BSD based hand held computing device. The profile mechanism could be part of the receivers table that the intercept alter device may generate, or add information to, based on the users browsing habits, or other user information available to the intercept alter device. Furthermore, as the intercept-alter device is on the user's machine the intercept-alter device could keep the list of user preferences on the users machine, accessing an external data store of information to find a data information table 52, and generate targeted user advertising without compromising the users privacy. In this manner targeted advertising may be generated even if a user has never been to a particular site before. One skilled in the art can see how the targeting would work equally well on the ISP of users, or on the ISP of many websites, such that user profiles could be generated and used by many different sites.

The intercept alter device may be used to alter text strings sent from chat servers to clients. Likewise it could be used in conjunction with newsgroups, electronic mail sent through SMTP, and instant messaging. It has information in a data store concerning the various protocols of these utilities and based on that information can alter the data transmitted.

The intercept-alter device may be used by a receiver, or be used by an ISP in front of a receiver, to edit out objectionable material. The intercept-alter device may be configured with words or phrases to be deleted from a document, or the intercept-alter device could be equipped with image recognition that may alter areas that are seen as having too much skin tone into a non-offensive graphic. The intercept-alter device may be more refined than merely blocking access to pages with too much skin tone. Rather it may have a facility to render such pages inoffensive by understanding the various image formats, and being able to alter the images so they are no longer offensive.

A content-server may have many different articles, but wish to have users see articles that are relevant to them. If the intercept-alter device has been able to track certain of the users preferences, then even if the user has never been to the content-server before, the intercept-alter device could choose which articles to place in the content servers sites based on previously defined user preferences.

The intercept-alter device may have a particular trademark image stored in some data store. For example assume the trademark is stored in a bitmap format. If the intercept-alter device intercepted an image where the intercept-alter device had sufficient information in the protocols table 50 to translate the intercepted image into a bitmap, the intercept-alter device may be able to compare each intercepted image to its (the intercept alter device's data store) stored bitmap image. In the event that the two images show a match, the intercept-alter device may replace the trademark with a newer, updated trademark. With an adequate knowledge of any data format, the intercept-alter device may thus be able to intercept and alter any data format appropriately.

Thus the reader will see how the embodiments provide easily configurable tools to allow for dynamic alteration of data, that may be used to update data easily, and to generate individualized content for the receivers of data, even when the sender of data may not have access to highly detailed information about the receiver.

Implementations that depend on the TCP/IP protocol have been shown. One skilled in the art will see how the descriptions may easily be altered to use UDP, by recognizing some ordering protocol, and having the intercept-alter device be able to re-request dropped packets. The skilled person will also appreciate how the intercept-alter device will work with any transmission protocol, with appropriate alterations necessary for that protocol.

It has been shown how the intercept-alter device will work with text data. It should be clear that the intercept-alter device may work equally well with any data format, provided that the intercept-alter device has the information necessary to decode and find matches in that data to other data the intercept-alter device has access to, and the intercept-alter device may alter the data being sent in some appropriate fashion. Accordingly, the scope of the invention should be determined not by the embodiments illustrated, but by the appended claims and their legal equivalents.

It is appreciated that certain features of the invention, which are for clarity, described in the context of separate embodiments may also be provided in combination in a single embodiment. Conversely, various features of the invention, which are, for brevity, described in the context of a single embodiment, may also be provided separately or in any suitable combination.

It will be appreciated by persons skilled in the art that the present invention is not limited to what has been particularly shown and described herein and above. Rather the scope of the present invention is defined by the appended claims and includes both combinations and sub-combinations of the various features described herein and above, as well as various modifications thereof which would occur to persons skilled in the art upon reading the foregoing description.

1. Apparatus for intercepting data communicated between a sender and a receiver, and conditionally altering that data, the apparatus comprising:
(a) an interception unit, capable of intercepting said communication,
(b) a memory for storing predetermined device settings,
(c) access functionality, associated with said interception unit, operable to access data with said intercepted communication, and
(d) a search and replace unit, associated with both said interception unit and said access functionality, being operable to conditionally alter the intercepted communication in response to said accessed data and said device settings.

2. The apparatus of claim 1 wherein said access functionality is operable to access a selection from the group consisting of:
(a)sender identification
(b)information about the sender
(c)receiver identification
(d)information about the receiver, and
(e)data type identification.

3. The apparatus of claim 1, wherein said settings include any one of a group comprising:
(a)information about data types the apparatus may intercept,
(b)users for whom data should be changed,
(c)data to be changed, and
(d)at least one way in which given data is to be changed for at least one user.

4. The apparatus of claim 1, said interception unit being connectable to intercept data from a computer network.

5. The apparatus of claim 4 wherein the sender of data and receiver of the data are respectively remotely located.

6. The apparatus of claim 4, wherein said computer network is a packet based network.

7. The apparatus of claim 6 wherein the network is a network selected from the group consisting of a
(a) TCP/IP based network,
(b) UDP based transmission
(c) ICMP based transmission
(d) IGMP based transmission
(e) TCP based transmission
(f) mobile device based network
(g) Ipv6 based network
(h) Ipv4 based network
(i) SMP based network.

8. The apparatus of claim 7 further comprising a message assembler operable to assemble complete messages from assorted packets.

9. The apparatus of claim 4, the interception unit being locatable on a sending computer.

10. The apparatus of claim 9 wherein the search and replace unit is operable to determine a structure of input data and to carry out said alteration within the framework of said determined structure.

11. The apparatus of claim 10 wherein the structure is a text data structure.

12. The apparatus of claim 11 wherein the structure defines content text, and tag data.

13. The apparatus of claim 12 wherein the search and replace unit is operable to selectively do one of adding, altering, or deleting data found in a selection from data in and around at least one of the group consisting of:
(a) the text
(b) and tags.

14. The apparatus of claim 10 wherein the structure is one of a group consisting of:
(a) the SGML format
(b) the HTML format
(c) the XML format
(d) the XHTML format
(e) the WAP format, and
(f) SMTP.

15. The apparatus of claim 14 wherein the search and replace unit is operable to find a selection from the group consisting of words and tags, and is further operable to do at least one of adding data, deleting data, and altering data that is part of the group of data in and data around that selection.

16. The apparatus of claim 15 capable of selectively doing at least one of adding, removing and altering data around and in the selection, wherein that data consists of at least one of the group consisting of:
(a)JavaScript
(b)VB Script
(c)Ecma Script
(d)links
(e)color
(g)images
(h)sounds
(i)multimedia
(j)fonts
(k)Flash
(l)tags
(m)pop-up menus
(n)pop-up windows.

17. The apparatus of claim 10 wherein the structured data is selected from the group consisting of
(a) image data,
(b) sound data, and
(c) multimedia data.

18. The apparatus of claim 17 wherein the data alteration consists of altering a selection from the group consisting of:
(a) the resolution of the data and
(b) the compression of the data.

19. The apparatus of claim 4 wherein the interception unit is locatable on a receiving computer.

20. The apparatus of claim 19 wherein the search and replace unit is operable to determine a structure of input data and to carry out a replacement within the framework of said determined structure.

21. The apparatus of claim 20 wherein the structure is a text data structure.

22. The apparatus of claim 21 wherein the structure defines content text, and tag data.

23. The apparatus of claim 22 wherein the search and replace unit is operable to selectively do one of adding, altering or deleting data found in a selection from data in and around a selection from the group consisting of:
(a) the text
(b) and tags.

24. The apparatus of claim 20 wherein said structure is selected from the group comprising:
(a) the SGML format
(b) the HTML format
(c) the XML format
(d) the XHTML format
(e) the WAP format, and
(f) SMTP.

25. The apparatus of claim 24 wherein the search and replace unit is operable to find a selection from the group consisting of words and tags, and is capable of doing at least one of adding data, removing data, and altering data from any of a group comprising data in, and data around said selection.

26. The apparatus of claim 25 capable of carrying out at least one of adding, removing and altering data from any of data in and data around the selection, wherein the data consists of at least one of the group consisting of:
(a)JavaScript
(b)VB Script
(c)Ecma Script
(d)links
(e)color
(g)images
(h)sounds
(i)multimedia
(j)fonts
(k)Flash
(l)tags
(m)pop-up menus
(n)pop-up windows.

27. The apparatus of claim 19 wherein the structured data is selected from the group consisting of
(a) image data,
(b) sound data, and
(c) multimedia data.

28. The apparatus of claim 27 wherein the data alteration consists of altering a selection from the group consisting of:
(a) the resolution of the data and
(b) the compression of the data.

29. The apparatus of claim 4 wherein the intercepting unit is locatable on an intermediate network node, between the computer sending the data and the computer receiving the data.

30. The apparatus of claim 29, wherein said node is a gateway node.

31. The apparatus of claim 29, wherein said node is a proxy node.

32. The apparatus of claim 29, wherein said node is an ISP node.

33. The apparatus of claim 29 wherein the search and replace unit is operable to determine a structure of input data and to carry out a replacement within the framework of said determined structure.

34. The apparatus of claim 33 wherein the structure is a text data structure.

35. The apparatus of claim 34 wherein the data structure comprises content text, and tag, data.

36. The apparatus of claim 35 wherein the search and replace unit is operable to carry out at least one of adding, altering and deleting data found in any one of a group of data in and data around a selection from the group consisting of:
(a) the text and
(b) the tags.

37. The apparatus of claim 33 wherein said structure is one of a group consisting of:
(a) the SGML format
(b) the HTML format
(c) the XML format
(d) the XHTML format
(e) the WAP format, and
(f) SMTP.

38. The apparatus of claim 37 wherein the search and replace unit is operable to find a selection from the group consisting of words and tags, and is further operable to do at least one of add data, removing data and altering data, which can be found in and around said selection.

39. The apparatus of claim 15 capable of selectively doing at least one of adding, removing, and altering data around and in the selection, wherein that data consists of a at least one of the group consisting of:
(a)JavaScript,
(b)VB Script,
(e)Ecma Script,
(d)links
(e)color,
(g)images,
(h)sounds,
(i)multimedia,
(j)fonts,
(k)Flash,
(l)tags,
(m)pop-up menus, and
(n)pop-up windows.

40. The apparatus of claim 29 wherein the structured data is selected from the group consisting of
(a) image data,
(b) sound data, and
(c) multimedia data.

41. The apparatus of claim 40 wherein the data alteration consists of altering a selection form the group consisting of:
(a) the resolution of the data, and
(b) the compression of the data.

42. A Server on a network with
(a) functionality to intercept data being sent,
(b) memory for storing, predetermined settings,
(c) access functionality associated with said interception functionality operable to access data within said intercepted communication
(d) a search and replace unit, associated with both said interception unit and said access functionality being operable to conditionally alter the intercepted communication in response to said access data settings.

43. A data carrier carrying data usable in combination with a general purpose computer to provide
(a) functionality to intercept data being sent,
(b) memory for storing predetermined settings,
(c) access functionality associated with said interception functionality operable to access data within said intercepted communication
(d) a search and replace unit, associated with both said interception unit and said access functionality being operable to conditionally alter the intercepted communication in response to said access data and settings.

44. A method for intercepting communications between a sender and a receiver, and conditionally altering the intercepted data comprising:
(a)intercepting the communication,
(b)accessing data from within the intercepted communication,
(c)searching through and conditionally altering the communication and,
(d)forwarding said conditionally altered data onto the intended receiver.

45. The method of claim 44 wherein the data within the intercepted communication is a selection from the group consisting of:
(a) sender identification,
(b) information about the sender,
(c) receiver identification,
(d) information about the receiver, and
(e) data type information.

46. The method of claim 44 comprising intercepting a communication on a computer network.

47. The method of claim 46 wherein the sender of data and receiver of the communication are respectively remotely located.

48. The method of claim 47 comprising intercepting a communication from a packet-switched network.

49. The method of claim 48 comprising intercepting communication wherein said network is one of a:
(a) TCP/IP based network,
(b) UDP based transmission,
(c) ICMP based transmission,
(d) IGMP based transmission,
(e) TCP based transmission,
(f) mobile device based network,
(g) Ipv6 based network
(h) Ipv4 based network, and
(i) an SMP based network.

50. The method of claim 49 comprising receiving message parts in separate packets and assembling said packets to form at least one entire message.

51. The method of claim 50 comprising detecting a data structure and altering data within in such a way as to conform to said detected structure.

52. The method of claim 51 comprising altering text data.

53. The method of claim 52 wherein the text data comprises content text, and tag data.

54. The method of claim 53 wherein conditionally altering comprises adding data around a selection from the text and the tags.

55. The method of claim 51, wherein the structure is any one of a selection from the group consisting of
(a) the SGML format
(b) the HTML format
(c) the XML format
(d) the XHTML format
(e) the WAP format, and
(f) SMTP.

56. The method of claim 55 wherein said searching through and conditionally altering comprises finding a selection from the group consisting of words and tags, and selectively carrying out at least one of adding, removing and altering data which is at least one of in, and data around said selection.

57. The method of claim 56 wherein the data is selected from the group consisting of:
(a)JavaScript
(b)VB Script
(c)Ecma Script
(d)links
(e)color
(g)images
(h)sounds
(i)multimedia
(j)fonts
(k)Flash
(l)tags
(m)pop-up menus
(n)pop-up windows.

58. The method of claim 44, wherein said step of conditionally altering comprises altering said communication in accordance with predetermined settings.

59. The method of claim 44, wherein said step of conditionally altering comprises altering said communication in accordance with said accessed data.

60. The method according to claim 44, wherein said conditionally altering comprises altering said communication in accordance with said accessed data taken together with pre-determined settings.

61. The method of claim 51 wherein the structured data is selected from the group consisting of
(a) image data,
(b) sound data, sound
(c) multimedia data.

62. The method of claim 61 wherein the data alteration consists of altering a selection form the group consisting of:
(a) the resolution of the data, and
(b) the compression of the data.
